(19) United States
(12) Patent Application Publication
(10) Pub. No.: US 2007/0084178 A1
(43) Pub. Date: Apr. 19, 2007

(54) LEAF PICKUP RAKE

(76) Inventor: Todd A. Stevens, Jamestown, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/459,658

(22) Filed: Jul. 25, 2006

Related U.S. Application Data
(63) Continuation-in-part of application No. 11/252,306, filed on Oct. 17, 2005, now abandoned.

(51) Int. Cl. A01D 7/00

(52) U.S. Cl. 56/400.12

(57) ABSTRACT

A leaf pickup tool. A stationary rake head is fixedly mounted to a rod. A movable rake head is pivotally mounted to the stationary rake head with movement controlled by means of a handle slidably mounted to the rod and connected to the movable rake head by a rigid member. A spring associated with the handle allows for positioning of the movable rake head relative to the stationary rake head.

### CROSS-REFERENCE TO RELATED APPLICATION

This application is a continuation-in-part of U.S. patent application Ser. No. 11/252,306, filed Oct. 17, 2005.

### BACKGROUND OF THE INVENTION

1. Field of the Invention

The present invention relates generally to the field of garden rakes.

2. Description of the Prior Art

A variety of garden rakes have been devised for raking leaves and other debris on lawns, gardens and various fields. Once the leaves are raked into a pile, the leaves are typically deposited in a bag, container or other storage means. The leaves may be picked up with one's hands or raked onto a tarpaulin or sheet with the tarpaulin or sheet then being manually lifted and carried to the storage area. A further technique is to provide a rake having a type of device for trapping the leaves on the rake with the rake then being moved to the storage area and opened allowing the leaves to fall therefrom. The latter technique is employed by the rake disclosed herein.

A number of U.S. patents have been granted on leaf pickup rakes. Typically, a pair of mutually opposed rakes mounted to a rod are manipulated to move the rakes together trapping leaves therebetween. Another approach is to provide a member mounted to the rake handle that will move downwardly toward the rake tines thereby trapping leaves therebetween. A representative sample of these U.S. patents are as follows: U.S. Pat. No. 3,601,966 issued to Kerry; U.S. Pat. No. 3,095,682 issued to Pasquine; U.S. Pat. No. 5,303,536 issued to Tolliver; U.S. Pat. No. 6,502,381 issued Crites; U.S. Pat. No. 4,018,038 issued to Sipe; U.S. Pat. No. 6,272,827 issued to Hsu; U.S. Pat. No. 6,336,314 issued to Crevier; U.S. Pat. No. 5,765,351 issued to Frankhouser; U.S. Pat. No. 4,378,671 issued to Gascon; U.S. Pat. No. 2,504,943 issued to Zifferer; U.S. Pat. No. 4,185,448 issued to Blanco; U.S. Pat. No. 4,545,189 issued to Nelson; U.S. Pat. No. 6,134,869 issued to Barrett; and U.S. Pat. No. 6,151,878 issued to Kalavitis. Thus, a known technique is to mount a pair of mutually opposed rakes to the bottom of the rake handle. The tines of the rakes are offset and are forced by means of a spring to intertwine. Spring bias may be overcome forcing the tines apart to receive leaves therebetween.

Frequently, the rake tines will retain leaves since the tines pierce the leaves. In those rakes that have mutually opposed tines urged together, it becomes difficult to remove the pierced leaves from the tines. The user must overcome the spring bias urging the tines together while simultaneously picking the pierced leaves from the tines. Disclosed herein is an improved pickup rake that in the preferred embodiment includes a handle that automatically locks to the rake rod holding the tines in a spaced apart position allowing the user to then pick the leaves from the tines. In an alternate embodiment a pair of mutually opposed rakes are normally spaced apart. Thus, pierced leaves may be picked off the tines and/or the rake may be shaken to remove the leaves. The alternate embodiment of the rake includes spring biasing to move the pair of rakes to an intermediate position trapping leaves therebetween without the leaves being intertwined. A locking handle is further provided holding the tines in an intertwined position for storage of the rake.

### SUMMARY OF THE INVENTION

One embodiment of the present invention is a rake comprising a rod and a first rake head and a second rake head mounted to the rod and having respectively first tines and second tines. The first rake head is immovably mounted to the rod whereas the second rake head is pivotally mounted to the rod. The second rake head has relative to the first rake head an open position, an intermediate position, and a closed position. The second tines are spaced apart a first distance from the first tines when the second rake head is in the open position and spaced apart a second distance from the second tines less than the first distance when in the intermediate position. The second tines are intertwined with the first tines when the second rake head is in the closed position. A handle is slidably mounted to the rod and connected to the second rake head moving together as a unit. The handle has a top position, a bottom position and an in between position corresponding to the second rake being in the open position, the closed position, and the intermediate position. A spring is positioned on the handle biasing the handle in a locked position on the rod limiting relative motion between the handle and the rod but being yieldable allowing the handle to be moved lengthwise along the rod to allow the handle to move the second rake head to and from the open position, the intermediate position, and the closed position. A control lever is movably mounted to the handle to control the position of the handle relative to the rod.

It is as an object of the present invention to provide a new and improved pickup rake.

A further object of the present invention is to provide a leaf pickup rake having an open position to allow dislodgement of leaves resting on the rake tines.

Related objects and advantages of the present invention will be apparent from the following description.

### BRIEF DESCRIPTION OF THE DRAWINGS

FIG. 1 is a fragmentary side view of an alternate embodiment of a leaf pickup rake incorporating the present invention and shown in the open position.

FIG. 2 is the same view as FIG. 1 except the mutually opposed rakes are positioned in an intermediate position between the fully closed position and the open position.

FIG. 3 is a perspective view of the leaf pickup rake in the open position.

FIG. 4 is the same view as FIG. 3 only showing the rake in a fully closed position with the rake tines intertwined.

FIG. 5 is the same view as FIG. 4 only showing the rake in an intermediate position between the open and closed position.

FIG. 6 is a cross-sectional view taken along line 6-6 of FIG. 5 and viewed in the direction of the arrows.

FIG. 6A is an enlarged view of FIG. 6.

FIG. 7 is a fragmentary side view of a second alternate embodiment of the rake incorporating the present invention with the rake shown in the open position.

FIG. 8 is the same view as FIG. 7 only showing the rake in the intermediate position and the handle fragmented to illustrate the inner structure.

FIG. 9 is a cross sectional enlarged view showing the handle in the locked position.

FIG. 10 is the same view as FIG. 9 only showing the handle in the unlocked position.

FIG. 11 is a cross sectional view taken along the line 11-11 of FIG. 10 and viewed in the direction of the arrows showing the locking plate relative to the rake rod.

FIG. 12 is a cross sectional view taken along the line 12-12 of FIG. 10 and viewed in the direction of the arrows showing the control lever relative to the rake rod.

FIG. 13 is a fragmentary side view of the preferred embodiment of the rake incorporating the present invention with the rake shown in the open position.

FIG. 14 is the same view as FIG. 13 only showing the rake in the intermediate position and the handle fragmented to illustrate the handle construction.

FIG. 15 is a perspective view of the leaf pickup rake of FIG. 13 only showing the rake in a fully closed position with the rake tines intertwined.

FIG. 16 is an enlarged perspective view of the handle for the rake of FIG. 13 without the control lever mounted thereto.

FIG. 17 is an enlarged cross-sectional view of the control lever that is mounted to the handle of FIG. 16.

### DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

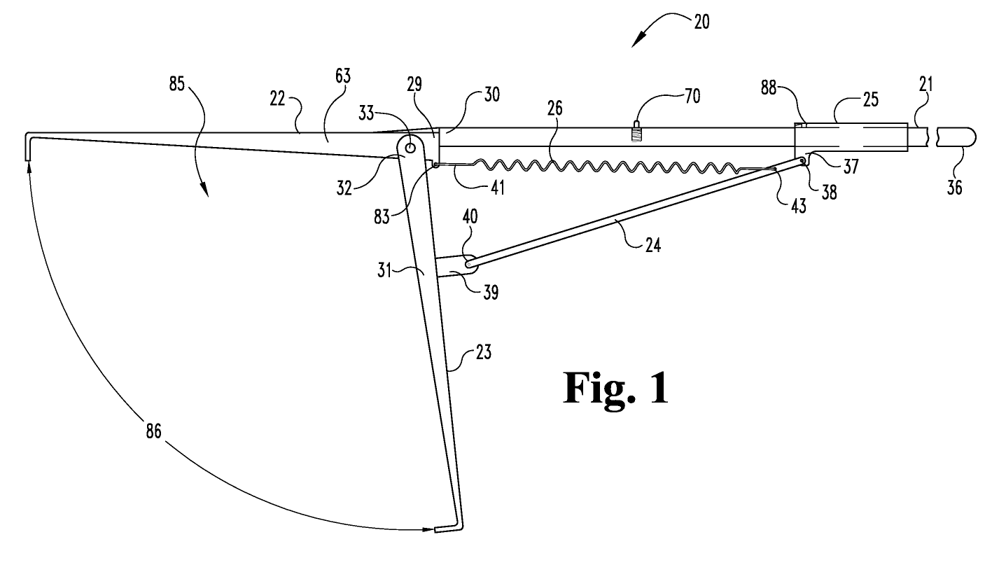

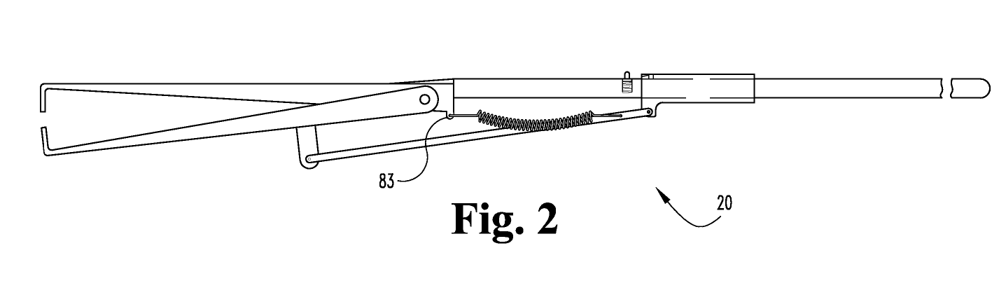

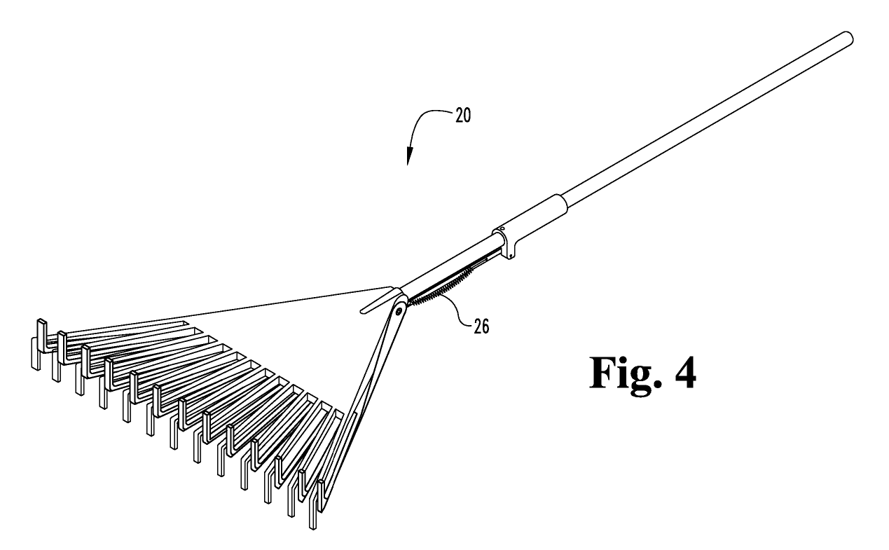

Referring now more particularly to FIG. 1, there is shown the first alternate embodiment of the leaf pickup rake 20 incorporating the present invention. Rake 20 includes a rod 21 having a top end portion 36 and a bottom end portion 30. A pair of rakes 22 and 23 are mounted to rod 21. Rake 22 is fixedly mounted to the rod whereas rake 23 is pivotally mounted to rake 22 allowing rake 23 to move from an open position (FIG. 1) to an intermediate position (FIG. 2). Further, rake 23 may be moved from the intermediate position (FIG. 2) to a closed position (FIG. 4) whereat the mutually opposed rake tines are intertwined.

A handle 25 is slidably mounted to rod 21 and has a passage extending therethrough to slidably receive the rod. The passage extending through the handle is of complementary shape to the cross section of the rod to ensure for proper sliding motion. For example, in the event rod 21 has a cylindrical cross section then the passage extending through the handle is cylindrical. As a further example, rod 21 may have a square cross section that is slidably received by a complementary square passage extending through the handle. Alternative configurations are included in the present invention.

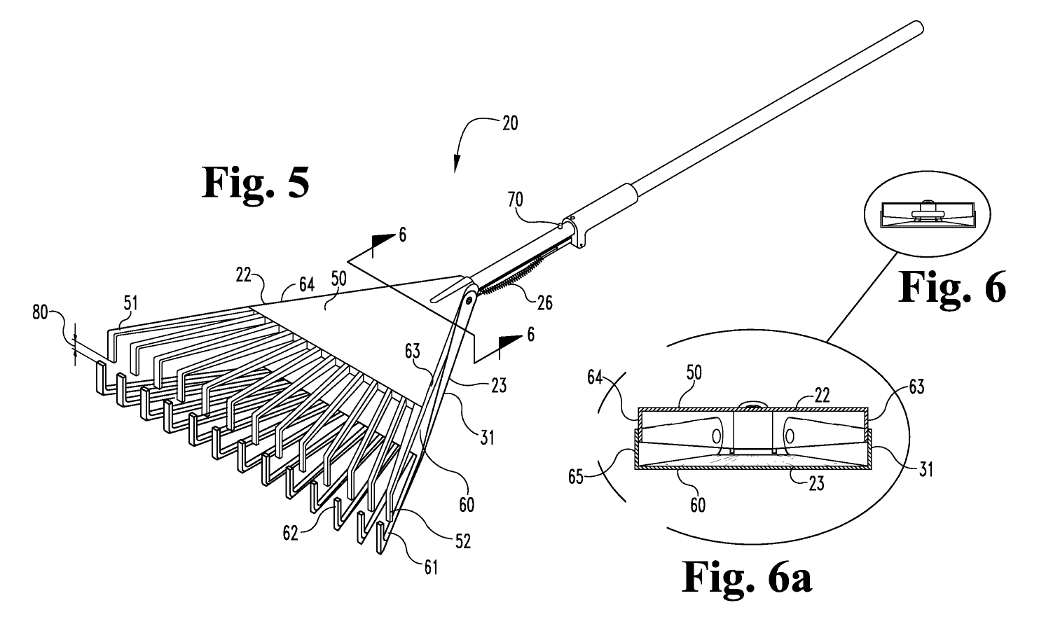

A rigid member or rod 24 has a first end pivotally mounted by pin or fastener 38 to arm 37 extending outwardly from the main body of handle 25. The opposite end of member 24 is pivotally mounted by pin 40 to upstanding bracket 39 fixedly mounted to the main body 60 (FIG. 5) of rake 23.

A helical spring 26 has a first end mounted to and extending through hole 43 provided in member 24 with hole 43 being located adjacent handle 25. The opposite end 41 of the helical spring extends through hole 83 provided in an outwardly extending flange formed in top end 29 of rake 22.

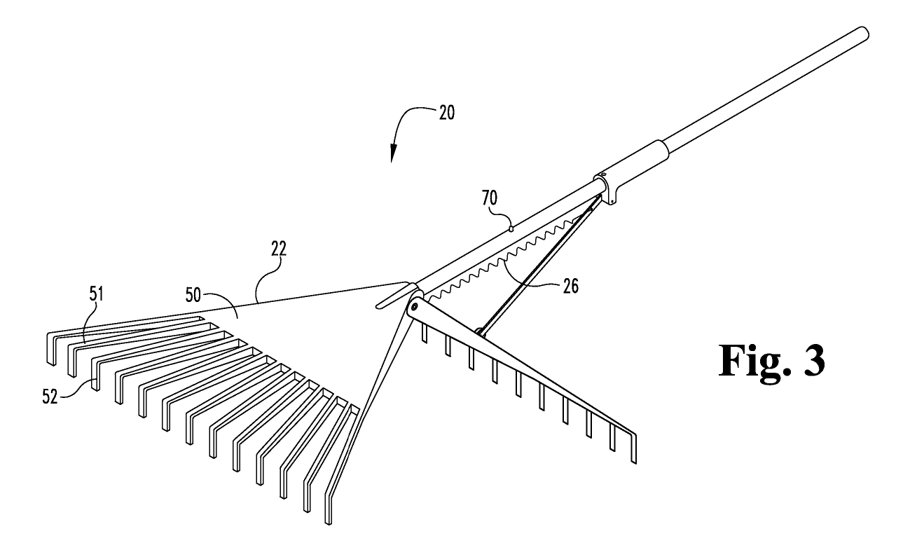

Rake 22 includes a flat main body 50 (FIG. 3) with a plurality of tines 51 cantileveredly mounted thereto. The distal ends 52 of each tine 51 are bent at a right angle and extend toward rake 23 when the rake is in the intermediate position (FIG. 2). Likewise, rake 23 (FIG. 5) includes a flat main body 60 having a plurality of tines 61 cantileveredly mounted thereto with the outer distal ends 62 formed at right angles and extending toward distal ends 52 of tines 51 when the rakes are in the intermediate position depicted in FIGS. 2 and 5. Distal ends 52 and 62 are spaced apart a distance 80 when the rakes are in the intermediate position.

The longitudinal extending edges of each rake are formed at right angles to the main bodies of the rakes. For example, rake 22 has a longitudinally extending side wall 63 extending along one side of main body 50 (FIG. 6a) from the top end 29 (FIG. 1) of main body 50 to the location where the tines 51 are mounted. Similarly, the opposite extending sidewall 64 (FIG. 6A) of main body 50 extends from top end 29 to tines 51. Sidewalls 63 and 64 are positioned inwardly of the sidewalls 31 and 65 formed on rake 23. For example, wall 63 is positioned within and adjacent sidewall 31 formed at a right angle with respect to the rake main body 60. Similarly, side wall 64 of rake 22 is positioned inwardly and adjacent sidewall 65 formed at a right angle with respect to main body 60 of rake 23 (FIG. 6A).

Main body 50 of rake 22 is fixedly mounted to the bottom end portion 30 (FIG. 1) of rod 21. Rod 21 extends between main body sidewalls 63 and 64 (FIG. 6) and is secured thereto by any number of conventional means, such as threaded fasteners or pins. The proximal ends of walls 31 and 65 (FIG. 6A) of main body 60 of rake 23 form a pair of ears pivotally mounted to sidewalls 64 and 63. For example, sidewall 31 includes a proximal end 32 (FIG. 1) forming an ear pivotally mounted by pin 33 to sidewall 63 of the stationary rake 22. Likewise, sidewall 65 includes a proximal end forming an ear or flange located adjacent sidewall 64 of the stationary rake 22 that is pivotally mounted by means of a pin. The proximal end 29 of sidewall 63 includes an ear having a hole 83 through which end 41 of helical spring 26 extends.

In order to operate rake 20, handle 25 is grasped and pulled upwardly towards the top end 36 of rod 21. Since rigid member 24 is pivotally connected to the handle and rake 23, the handle along with member 24 and rake 23 move as a unit causing rake 23 to move to the open position depicted in FIG. 1 forming a leaf receiving cavity 85 with the distal ends of rakes 22 and 23 spaced apart a first distance 86. The leaves may then be forced into cavity 85 with handle 25 then being moved away from top end 36. Helical spring 26 urges handle 25 away from the top end of the rod since it is connected between the stationary rake 22 and the top end of rigid member 24. Eventually, leaves will be trapped between stationary rake 22 and movable rake 23. The spring urges the rakes to hold the leaves therebetween. Spring 26 is operable to continue to apply bias to handle 25 until the rakes are in the intermediate position depicted in FIG. 5 at which time the spring becomes slack or limp thereby no longer exerting a spring bias. Once the leaves are trapped between the stationary and movable rake, the rake may be carried to a leaf storage area with the handle then being moved towards the top end of the rod allowing the leaves to fall from the leaf cavity. The process may then be repeated.

When the rake is no longer in use and is to be stored, the movable rake is moved adjacent the stationary rake. The tines of rake 22 are offset from the tines of rake 23 thereby allowing the tines of rake 22 to intertwine with the tines of rake 23 when the rake is in the closed position as depicted in FIG. 4. In the closed position of FIG. 4, spring 26 does not exert a spring bias and is limp or is slack.

A spring biased depressible button 70 is mounted to rod 21 and is extendable through a hole 88 provided in the bottom end of handle 25. Button 70 is of conventional design and includes a spring located within the rod that normally urges the top end of button 70 outwardly. The button may be depressed in order to be able to move the handle over the button until the button extends outward through hole 88. Button 70 is located so as to position the handle to cause the stationary rake and movable rake to be in the closed and intertwined position of FIG. 4.

In many cases, distal ends 52 and 62 of tines 51 and 61 will pierce leaves thereby causing the leaves to be held by the tines even if the stationary and movable rake are fully opened to the position depicted in FIG. 1. In order to remove the leaves, while the rakes are positioned in the open position of FIG. 1, it is necessary to hold handle 25 relative to rod 21 in the upper position against the bias of spring 26 while at the same time the leaves are manually pulled from the tine distal ends. Thus, there is provided an intermediate position of the movable rake and stationary rake as depicted in FIGS. 2 and 5. The intermediate position of the rake is located between the closed position of FIG. 4 and the open position of FIG. 1. In the intermediate position, spring 26 does not exert a spring bias on handle 25 and is slack or limp. In such a state, the spring is in a relaxed condition. Thus, the user does not have to overcome the bias of spring 26 when the rake is in the intermediate position and may simply reach towards the leaves upon the tine distal ends and remove the leaves therefrom. The rake therefore saves time and is easier to use.

In order to move the stationary and movable rake from the intermediate position of FIG. 5 to the closed position of FIG. 4, handle 25 must manually be pushed towards the bottom end of the rod without any bias from the spring being exerted. The spacing of the distance 80 between opposite distal ends of the rakes in the intermediate position is less than the distance 86 between distal ends of the rakes when the rakes are in the open position.

In order to use rake 20 to rake leaves and debris, the rake is moved to the closed position depicted in FIG. 4. The rake is moved across the ground with the tines of the stationary rake 22 being used to gather the leaves. Handle 25 is then pulled towards the top end of rod 21 causing the movable rake 23 to open. The rake can then be placed over the debris pile with the handle 25 then being moved away from the top end 36 of the rake causing the movable rake 23 to move towards the stationary rake 22 holding the yard debris until it is ready to be released over a storage area.

There are many advantages resulting from the subject invention. A rake and a pickup tool is provided in a single device. Further, debris may be picked up while the tension spring allows the debris to be held in place since the rakes 22 and 23 are urged to hold the debris. In addition, leaves may be removed from the tines when the rake is in the intermediate position without a requirement that the spring bias be overcome. When the rakes are in the intermediate position of FIG. 5, leaves and debris move from between the rakes.

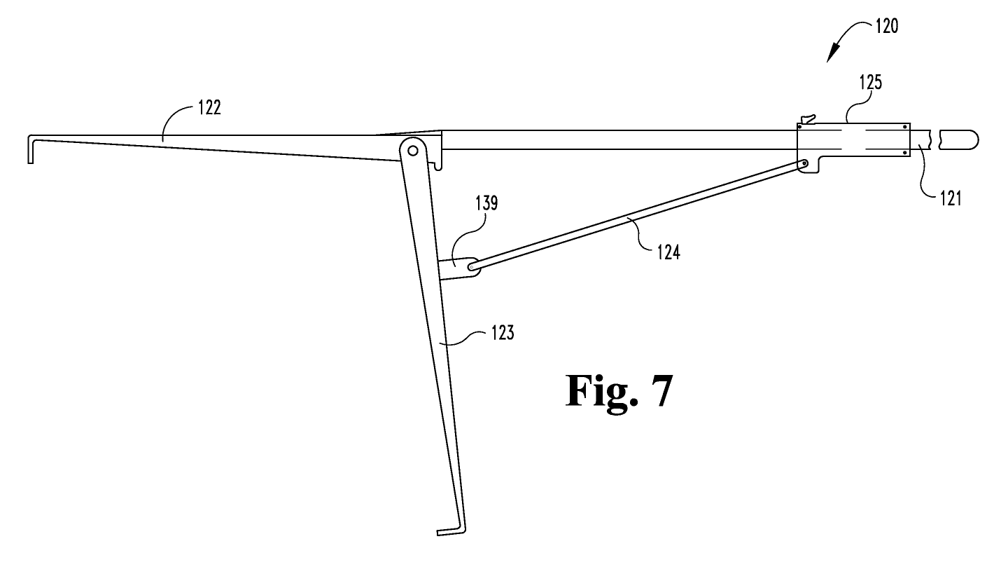

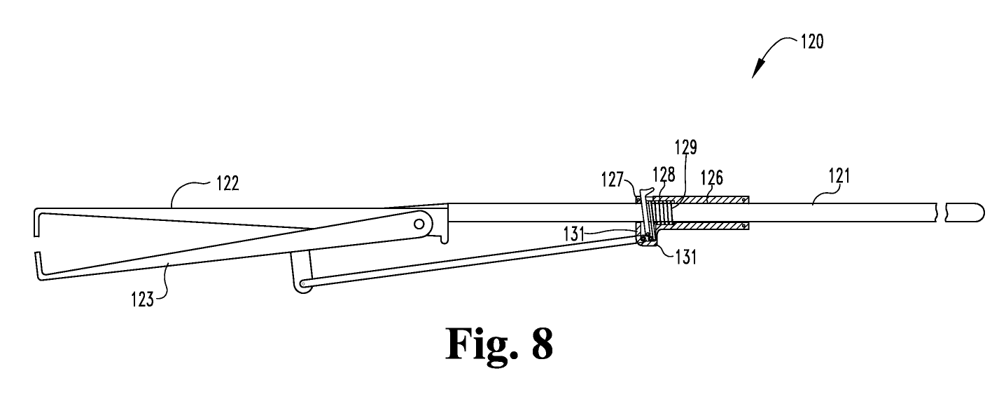

The second alternate embodiment of the rake is shown in the open position in FIG. 7 and in the intermediate position in FIG. 8. Rake 120 includes a rod 121 having a first rake head 122 fixedly mounted to the bottom end thereof with a movable rake head 123 pivotally mounted to the first rake head in a manner identical to described and shown herein for rake 20. Likewise, a rigid member 124 has a bottom end pivotally mounted to an upstanding flange 139 fixed mounted to rake head 123 while the top end of member 124 is pivotally mounted to handle 125 as previously described and shown for rake 20. Rake heads 122 and 123 are identically configured and shaped as described and shown for rake heads 22 and 23. That is, each rake head has a main body with a plurality of tines cantileveredly mounted thereto with the distal ends of rake head 122 pointed toward and interspaced between the mutually facing distal ends of the tines of rake head 123 when the rake heads are in the intermediate position of FIG. 8.

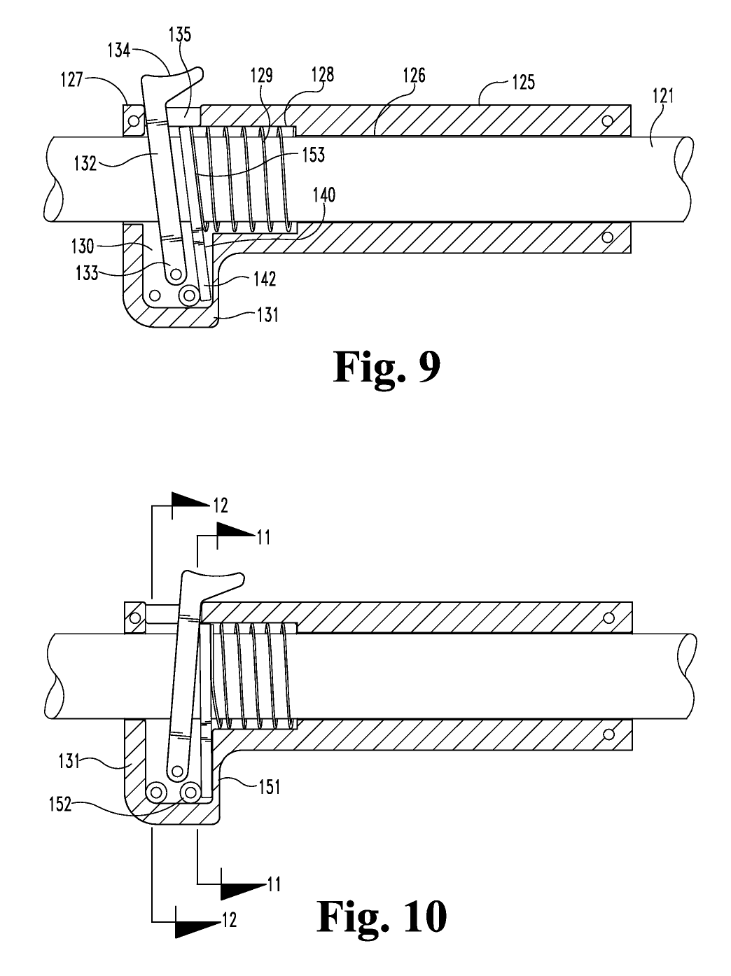

Handle 125 is constructed different from handle 25. Further, spring 26 is not utilized in the embodiment of FIG. 7. Handle 125 (FIG. 9) includes a main body having a central passage 126 extending therethrough being complementary in shape to the outside surface of rod 121 with the rod extending through passage 126. Passage 126 is enlarged at the end 127 closest to the rake heads forming a spring cavity 128 in which a helical spring 129 is located extending around rod 121. Cavity 128 includes a side recess 130 formed in arm 131 extending laterally from the main body of the handle.

A position control lever 132 has a proximal end 133 pivotally mounted to arm 131 with the lever being positioned within recess 130 and cavity 128. The distal end 134 of lever 132 extends outwardly from cavity 128 through slot 135 formed in handle 125. Lever 132 includes a hole 160 (FIG. 12) that is oversized relative to rod 121. Rod 121 extends through hole 160. The lever does not contact rod 121 when it is in either the position corresponding to when plate 140 is locked (FIG. 9) or when plate 140 is unlocked (FIG. 10).

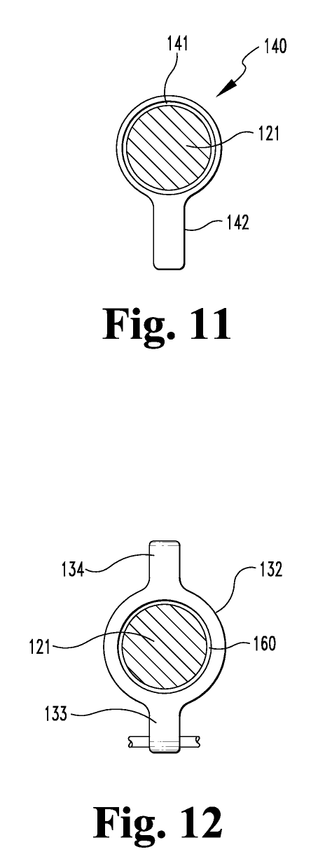

A release and locking plate 140 has a main body with a hole 141 (FIG. 11) through which rod 121 extends. Plate 140 is positioned within cavity 128 and has a reduced width pivot finger 142 positioned within recess 130. Finger 142 is positioned between and adjacent the side wall 151 (FIG. 10) of arm 131 and molded pin 152 extending across recess 130. Plate 140 is pivotable about the end of finger 142 from a position (FIG. 10) perpendicularly arranged relative to the longitudinal centerline of rod 121 to a position (FIG. 9) whereat the plate is skewed relative to the longitudinal centerline of rod 121. Plate 140 is located between end 153 of spring 129 and the main body of lever 132 and is movable back and forth between the locked position (FIG. 9) to the unlocked position (FIG. 10). Hole 141 (FIG. 11) is oversized relative to rod 121. For example, if rod 121 is cylindrical, then hole 141 is circular with an inside diameter greater than the outside diameter of rod 121. Thus, when plate 140 is perpendicular (FIG. 10) to rod 121, the plate does not interfere with rod 121 allowing handle 125 to freely slide to any position along the length of rod 121 whereas when the plate is in the skewed position (FIG. 9), plate 140 is in the locked position interferingly contacting rod 121 and preventing relative motion between the handle 125 and rod 121.

In order to move rake head 123 relative to rake head 122, the distal end 134 of finger 132 is pulled back against spring 129 causing plate 140 to move from the locked position of FIG. 9 to the unlocked position of FIG. 10 thereby allowing the handle to be moved to the desired location along the length of rod 121 to control the spacing of rake head 123 relative to rake head 122. When the desired position is reached, finger 132 is released with spring 129 forcing plate 140 to assume the skewed position locking the handle and rake head 123 in place. Rake heads 122 and 123 may be moved to the closed position (FIG. 4) depicted for rake 20 by moving handle 125 to the closest position possible relative to the rake heads.

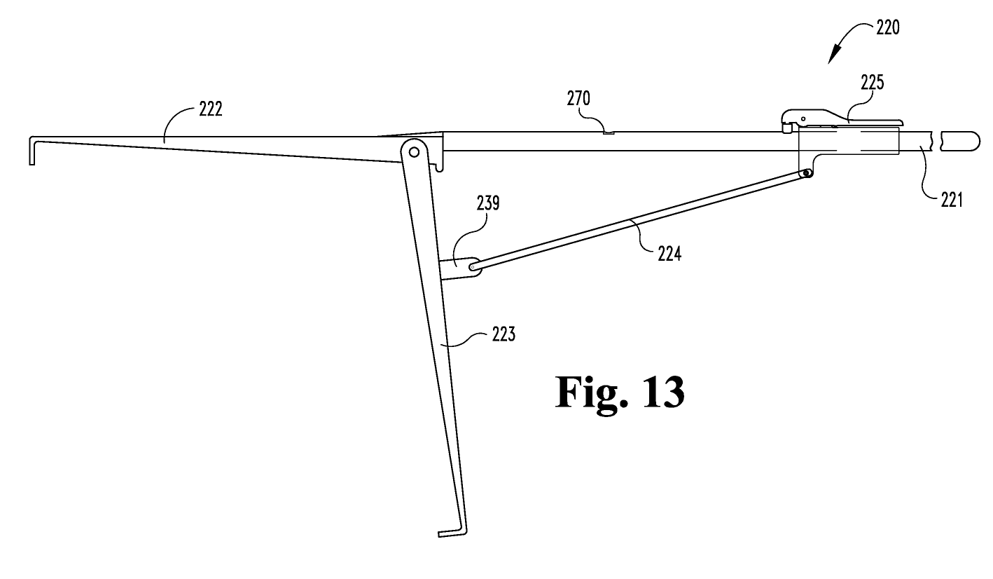

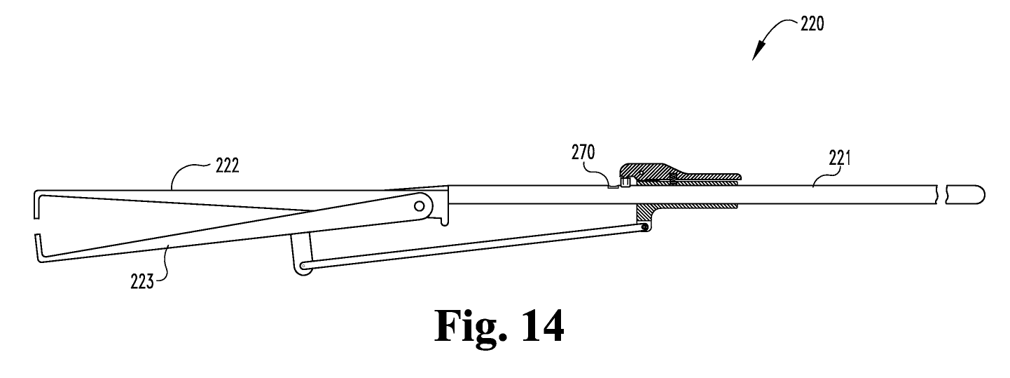

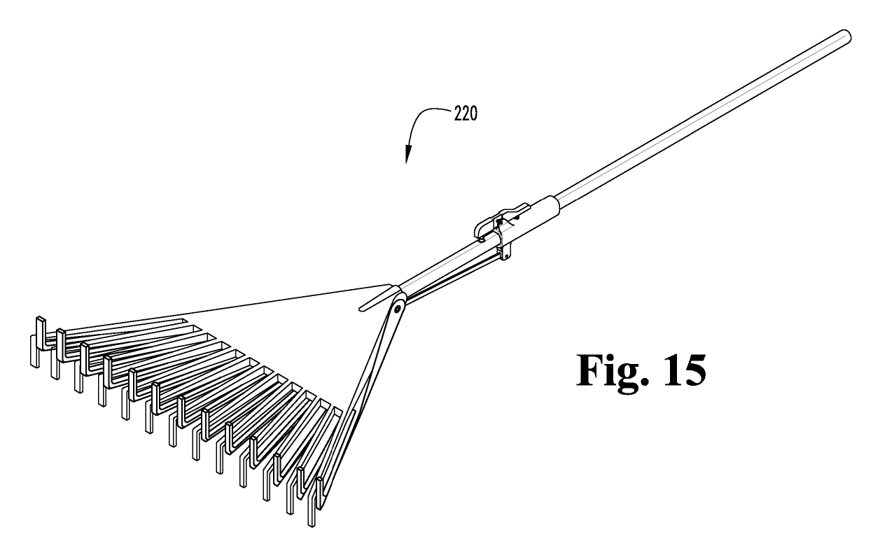

The preferred embodiment of the rake is shown in the open position in FIG. 13, in the intermediate position in FIG. 14 and the closed position in FIG. 15. Rake 220 includes a rod 221 having a first rake head 222 fixedly mounted to the bottom end thereof with a movable rake head 223 pivotally mounted to the first rake head in a manner identical to describe and shown for the other rakes disclosed herein. A rigid member 224 has a bottom end pivotally mounted to an upstanding flange 239 fixedly mounted to rake head 223 while the top end of member 224 is pivotally mounted to handle 225. Rake heads 222 and 223 are identically configured and shaped as described and shown for the other rake heads disclosed herein. That is, each rake head has a main body with a plurality of tines cantileveredly mounted thereto with the distal ends of rake head 222 pointed toward and spaced between the mutually facing distal ends of the tines of rake head 223 when the heads are in the intermediate position of FIG. 14.

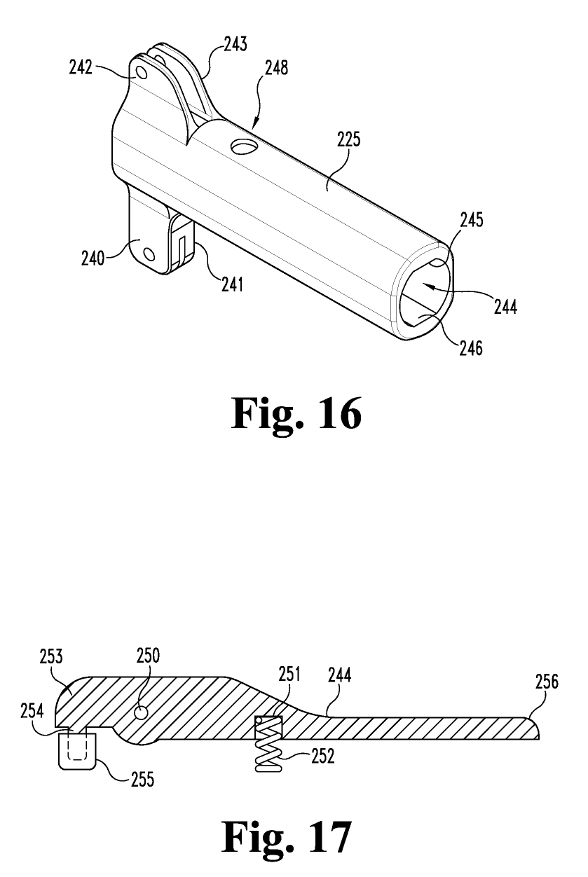

Handle 225 is constructed different from handles 25 and 125. Handle 225 (FIG. 16) has a pair of spaced apart flanges 240 and 241 between which the top end of member 224 extends and is pivotally mounted thereto by a pin or other fastening device. Flanges 240 and 241 extend from the bottom of handle 225 as viewed in FIG. 16, whereas a second pair of flanges 242 and 243 extend upwardly as viewed in FIG. 16. Flanges 242 and 243 are spaced apart to pivotally receive the main body of control lever 244.

The main body of handle 225 (FIG. 16) has a passage 244 extending through the length thereof and is complimentary in shape to the outside surface of handle 221. Handle 225 includes a pair of opposed flat surfaces 245 and 246 which extend the length of passage 244. Rod 221 likewise has a pair of outwardly facing flat surfaces to complimentary receive surfaces 245 and 246. Thus, as the handle is slidably moved along the length of the rod, the handle is prevented from rotating on the rod thereby maintaining the alignment of rod 224 extending between movable rake head 223 and handle 225.

Control lever 244 (FIG. 17) has an elongated shape and is pivotally mounted atop handle 225. Lever 244 extends between flanges 242 and 243 with a pin or other fastening device extending through hole 250 of the lever and then into flanges 242 and 243 pivotally mounting the lever to the handle. A downwardly opening blind hole 251 in the main body of the lever receives the top portion of a helical spring 252 that extends downwardly into a blind hole 248 (FIG. 16) of handle 225. A rubber stopper 255 is fixedly mounted to finger 254 that extends downwardly from end 253 of the lever. Hole 250 is located between end 253 and spring 252. The lever pivot axis extends through hole 250. Thus, spring 252 urges the lever in a clockwise direction as viewed in FIG. 17 causing the rubber stopper 255 to frictionally engage the upper flat surface of rod 221 releasably holding the handle in place and limiting relative motion between the handle and rod 221. A depression or hole 270 (FIG. 14) is located in the upwardly facing flat surface of rod 221 and is positioned along the length of rod 221 corresponding to the location of stopper 255 when the rake heads are in the closed position (FIG. 15) locking the handle in place.

In operation, end 256 of the lever is pushed downwardly by squeezing the lever toward the handle thereby moving stopper 255 apart from rod 221 and allowing the handle to be slidably moved along the length of rod 221 to the desired open position (FIG. 13), the intermediate position (FIG. 14) or the closed position (FIG. 15). Once the movable rake head 223 has been located the desired distance relative to the stationary rake head 222, the lever 244 may be released thereby forcing stopper 255 against the upwardly facing flat surface of the rake rod 221 securing the movable rake head in position relative to the stationary rake head. A particular advantage of the rake shown in FIG. 13 is that it will stand in an erect position when the rake heads are in contact with the ground or other supporting surface with the rake heads spread apart.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A rake comprising:
a rod;
a first rake and a second rake mounted to said rod and having respectively first tines and second tines, said first rake immovably mounted to said rod whereas said second rake is pivotally mounted to said rod, said second rake having relative to said first rake an open position, an intermediate position and a closed position, said second tines spaced apart a first distance from said first tines when said second rake is in said open position and spaced apart a second distance from said second tines less than said first distance when in said intermediate position, said second tines are intertwined with said first tines when said second rake is in said closed position;
a handle slidably mounted to said rod and connected to said second rake moving together as a unit, said handle having a top position, a bottom position and an in between position corresponding to said second rake being in said open position, said closed position, and said intermediate position;
a control lever movably mounted to said handle to control the position of said handle relative to said rod, said lever having a first position and a second position and a portion contacting said rod when said handle is in said first position and spaced apart from said rod when said handle is in said second position; and;
a spring biasing said control lever and handle in a locked position on said rod with said portion is in said first position limiting relative motion between said handle and said rod but being yieldable allowing said handle to be moved lengthwise along said rod when said portion is in said second position to allow said handle to move said second rake to and from said open position, said intermediate position, and said closed position; and,

2. The rake of claim 1 and further comprising:
a rigid member connected to and extending between said handle and said second rake to cause said handle and second rake to move as a unit.

3. The rake of claim 2 wherein:
said rigid member is pivotally connected to said handle and pivotally connected to said second rake.

4. The rake of claim 3 wherein:
said handle includes an upstanding flange having said control lever pivotally mounted thereto about a pivot axis with said axis being located between said portion and said spring.

5. The rake of claim 4 wherein:
said spring extends against said handle and said rod urging said control lever to pivot about said axis.

6. The rake of claim 5 wherein:
said handle has a passage through which said rod extends, said rod and said handle have complementary mating surfaces allowing said handle to slidably move on said handle while limiting rotation of said handle relative to said rod.

7. The rake of claim 6 wherein:
said rod includes an outwardly facing surface matable with said portion to limit relative motion between said handle and said rod.

8. The rake of claim 7 and further comprising:
a stopper mounted to said portion frictionally engaging said outwardly facing surface of said rod when said control lever is in said first position.

9. A rake for raking and picking up leaves comprising:
a rod for grasping and holding;
a pair of mutually opposed rakes mounted to said rod with said rakes movably mounted relative to each other to allow said rakes to move apart to an open position forming a cavity to receive leaves and to then move toward each other to an intermediate position to hold said leaves therebetween, said rakes further movable from said intermediate position to a closed position wherein said rakes are intertwined;
a handle slidably mounted on said rod and connected to one of said rakes moving together as a unit, said handle having a top position, a bottom position and an in between position corresponding to said one rake being in said open position, said closed position, and said intermediate position;
control means connected to said handle and one of said rakes, said control means including a pivot lever and a spring, said spring positioned relative to said handle biasing said lever in a locked position relative to said rod limiting relative motion between said handle and said rod but being yieldable allowing said lever to be pivoted away from said rod and said handle to be moved lengthwise along said rod and to move one of said rakes to and from said open position, said intermediate position, and said closed position.

10. The rake of claim 9 and further comprising:
a rigid member connected to and extending between said handle and said rakes to cause said handle and one of said rakes to move as a unit.

11. The rake of claim 10 wherein said rigid member is pivotally connected to said handle and pivotally connected to one of said rakes.

12. A rake comprising:
a rod;
a first rake head immovably mounted to said rod;
a second rake head movably mounted to said rod and having a open position and a closed position relative to said first rake head, said first rake head and said second rake head having mutually opposed tines that intertwine when said second rake head is in said closed position;
a handle slidably mounted to said rod and having a top position and a bottom position corresponding to when said second rake head is in said open position and said closed position;
a device connecting said handle to said second rake head so said second rake head moves in unison with said handle;
a control lever movably mounted on said handle and having a portion frictionally engaging said rod limiting relative motion between said handle and said rod but movable apart from said rod to allow said handle to slide on said rod between said top position and said bottom position, said control lever has a first end portion and a second end portion and is pivotally mounted therebetween to said handle; and
a spring engaging said first end portion and said handle to normally urge said second end portion toward said rod but yieldable to allow said first end portion to move toward said rod and said second end portion to move away from said rod.

13. The rake of claim 12 and further comprising:
a stopper mounted to said second end portion to engage a depression in said rod when said handle is in said bottom position locking said second rake head in said closed position.
